(19) United States
(12) Patent Application Publication
(10) Pub. No.: US 2014/0347564 A1
(43) Pub. Date: Nov. 27, 2014

(54) Wi-Fi ATSC TV Antenna With Waveform Compression

(71) Applicant: Lin Yang, (US)

(72) Inventor: Lin Yang, (US)

(21) Appl. No.: 13/902,947

(22) Filed: May 27, 2013

(51) Int. Cl. H04N 5/455

(52) U.S. Cl. CPC H04N 5/455
USPC 348/729

(57) ABSTRACT

A Wi-Fi ATSC TV Antenna with Waveform Compression is comprised of 5 components—TV antenna, ATSC TV tuner, AD Converter, Waveform Data Compression Unit, and Wi-Fi Transceiver. It is used to transfer Analog RF Waveform to Digital IF Signal over Wi-Fi to a TV-viewing device. It is used for ATSC TV reception devices.

### TECHNICAL FIELD

The device can be used to transfer Analog RF Waveform to Digital IF Signal over Wi-Fi to a TV-viewing device. It is used for ATSC TV reception devices.

### BACKGROUND

The television antenna has existed for decades, and has traditionally been mounted on rooftops and connected to the TV with a long wire. TVs have become thinner, sleeker, and available in more formats (portable TV, tablet, cell phone, etc.). The wired connection between the antenna and the above-mentioned TV-viewing device needs to be replaced with a wireless connection to cater to these new formats.

Additionally, recent advances in Wi-Fi technology have enabled very high speed transfer rates (1 Gbps). Due to this high speed, Wi-Fi now has the means to wirelessly connect single or multiple antennas to the TV viewing device.

The following patents are herein incorporated by reference: United States patent Dinstein U.S. Pat. No. 4,151,550; United States patent Kuhlmann US 2006/00266657; United States patent Decanne US 2008/0060024; United States patent Cirrincione US 2009/0158368; United States patent Cowley US 2010/0323636; U.S. patent application Ser. No. 13/872,917 entitled MULTIPLE ANTENNA ATSC HDTV RECEIVER DEVICE, by Yang; U.S. patent application Ser. No. 13/892,504 entitled ATSC TERRESTRIAL TV ANTENNA NETWORK, by Yang.

In addition to the above referenced applications, the present invention adds a Waveform Data Compression Unit to reduce the transmitted signal data rate.

### SUMMARY OF INVENTION

The object of the invention is to replace the wired connection between the TV and the antenna with a Wi-Fi connection.

This invention combines an ATSC Terrestrial Broadcast TV RF Analog Signal to IF Analog Signal Converter, a Waveform Data Compression Unit, and high-speed Wi-Fi transceiver to create a new device, a Wi-Fi ATSC TV Antenna with Waveform Compression.

### BRIEF DESCRIPTION OF DRAWINGS

Having thus described the invention in general terms, reference will now be made to the accompanying drawings, which are not necessarily drawn to scale, and wherein:

FIG. 1 shows schematically a block diagram of the Wi-Fi ATSC TV Antenna with Waveform Compression according to one embodiment of the present invention.

FIG. 2 shows schematically a block diagram of the TV Signal to Wi-Fi Signal Adapter according to one embodiment of the present invention.

### DETAILED DESCRIPTION

The present inventions now will be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.

### COMPONENT LIST

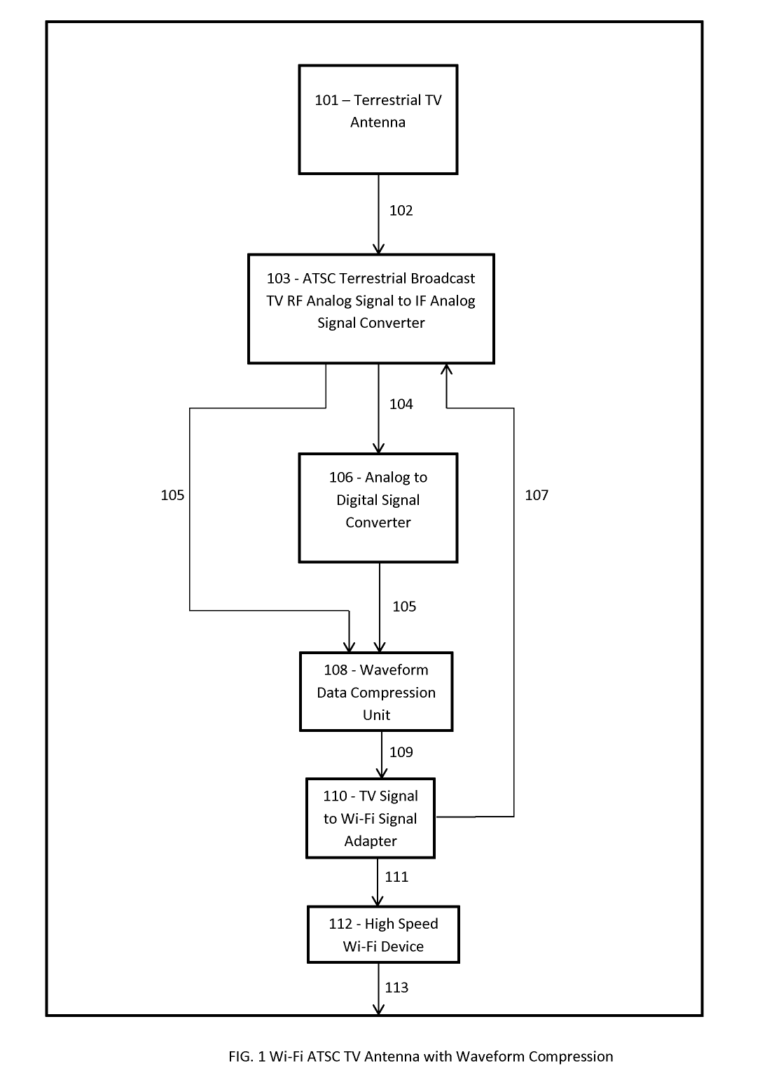

FIG. 1
100—Wi-Fi TV Antenna
101—Terrestrial TV Antenna
102—TV RF Signal Cable
103—ATSC Terrestrial Broadcast TV RF Analog Signal to IF Analog Signal Converter
104—Analog IF TV Signal
105—Digital IF TV Signal
106—Analog to Digital Signal Converter (106 is optional if the ADC is built-in the Tuner)
107—IF AGC Signal
108—Waveform Data Compression Unit
109—Compressed Digital IF TV Signal
110—TV Signal to Wi-Fi Signal Adapter
111—Input Signal to Wi-Fi
112—High Speed Wi-Fi Device
113—Wi-Fi RF Signal

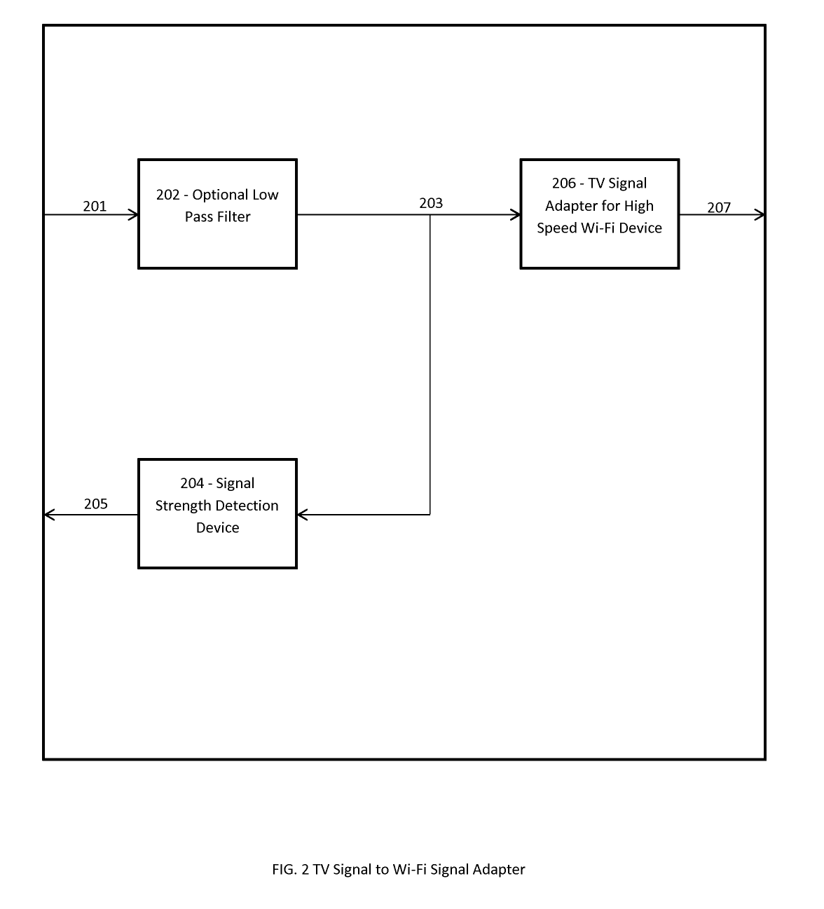

FIG. 2
201—Digital IF TV Signal
202—Optional Low Pass Filter
203—Filtered Digital IF TV Signal
204—Signal Strength Detection Device
205—IF AGC Signal
206—TV Signal Adapter for High Speed Wi-Fi Device
207—Input Signal to Wi-Fi

This invention uses the US Terrestrial TV ATSC standard—however other Terrestrial TV standards (DVB-T, ISDB-T, DMBT, etc.) can also be applied.

FIG. 1 is an example of the Wi-Fi ATSC TV Antenna (100).

Any terrestrial TV will have a common TV antenna (101) to receive the radio waveforms. Traditionally, the TV antenna is directly plugged in to the TV thru a TV RF signal cable (102). In this invention, the TV RF signal from the antenna is first connected to the ATSC Terrestrial Broadcast TV RF Analog Signal to IF Analog Signal Converter (103), which traditionally is inside the TV.

This invention has separated the tuner from the TV console, and put the tuner on the antenna side.

The output of the ATSC Terrestrial Broadcast TV RF Analog Signal to IF Analog Signal Converter (103) is in analog format (104). So, the analog IF ATSC TV signal (104) will be transformed to digital format by the ADC (106).

The ATSC Terrestrial Broadcast TV RF Analog Signal to IF Analog Signal Converter (103)needs an IF AGC (Automatic Gain Control) signal (107) to control the converter's signal dynamic range.

The Digital IF TV Signal (105) is a sampled waveform. The minimum sampling frequency (Nyquist Sampling Rate) is two times the ATSC TV signal baseband symbol rate which is 10.76 MSPS (Mega Symbols per Second). Any sampling frequency above the minimum sampling frequency can be used. In this example, the sampling frequency is 25 MHz and the ADC is 12-bit, therefore the Digital IF TV Signal (105) data rate is 300 Mbps (Mega Bits per Second). Since the bandwidth of the ATSC TV signal is 6 MHz, there is redundant information in the sampled digital IF TV signal (105). The waveform data compression unit (108) is applied to the sampled digital IF TV signal (105) in order to remove the redundancy and reduce the data rate of the signal.

The waveform data compression algorithm in 108 can be either the ADPCM (Adaptive Differential Pulse-Code Modulation) algorithm or the DPCM (Differential Pulse-Code Modulation) algorithm. For this example, the ADPCM algorithm is used. The output of the Waveform Data Compression Unit (108) is a Compressed Digital IF TV Signal (109) with the data rate of 100 Mbps. The Compressed Digital IF TV Signal (109) is fed in to the TV to Wi-Fi Adapter (110).

The TV to Wi-Fi Adapter (110) generates a Wi-Fi interface digital signal (111). This signal directly feeds in to the high speed Wi-Fi RF signal generator (112). The output is the Wi-Fi RF Signal (113). The TV to Wi-Fi Adapter (110) also generates an AGC signal (107) for the ATSC Terrestrial Broadcast TV RF Analog Signal to IF Analog Signal Converter (103).

FIG. 2 is an example of a TV Signal to Wi-Fi Signal Adapter (110)

The digital IF ATSC TV signal (201, also 109 FIG. 1) goes in to the optional low pass filter (202) to remove the adjacent channel interference. This filtered digital IF TV signal (203) goes to the signal strength estimator (204) which generates an IF AGC signal (205, also 107 FIG. 1). The filtered signal (203) also goes in to a high speed Wi-Fi interface signal adapter (206) to generate a Wi-Fi input signal (207, also 111 FIG. 1) to the high speed Wi-Fi device.

What is claimed is:

1. A device comprised of:
a. a Terrestrial TV antenna,
b. an ATSC Terrestrial Broadcast TV RF Analog Signal to IF Analog Signal Converter,
c. a 12-bit Analog to Digital Converter with 30 MHz bandwidth,
d. a Waveform Data Compression Unit, and
e. a Wi-Fi Transceiver.

2. (canceled)

3. (canceled)

4. (canceled)

5. (canceled)

6. (canceled)

7. (canceled)

8. (canceled)

9. (canceled)

10. A device of claim 1 with a DVB-T, ISDB-T, or DMB-T Terrestrial Broadcast TV Standards instead of ATSC Terrestrial Broadcast TV Standard
